(19) United States
(12) Patent Application Publication
(10) Pub. No.: US 2026/0131538 A1
(43) Pub. Date: May 14, 2026

(54) System and Method for Automated Post-Processing in Additive Manufacturing

(71) Applicant: Supernova Industries Corp., Austin, TX (US)

(72) Inventors: Roger Antunez Francisco, Barcelona (ES); Marta Mico Martinez, Barcelona (ES); Boris Agea Blanco, Barcelona (ES); Manuel Joao Martins Barroeta, Barcelona (ES); Eric Pallares Garcia, Barcelona (ES); Oriol Bel Laveda, Barcelona (ES)

(21) Appl. No.: 19/383,022

(22) Filed: Nov. 7, 2025

Related U.S. Application Data
(60) Provisional application No. 63/718,412, filed on Nov. 8, 2024.

(51) Int. Cl. B29C 64/393; B33Y 40/20; B33Y 50/02

(52) U.S. Cl. CPC B29C 64/393; B33Y 40/20; B33Y 50/02

(57) ABSTRACT

A method and system for post processing a component produced by an additive manufacturing machine, including analyzing one or more input parameters for a component produced by additive manufacturing machine and generating a post process recipe including a process parameter for at least one post processing step. The method further includes executing at least one post processing step with a post processing device using the process parameter and performing at least one quality measurement associated with the at least one post processing step. The method further includes adjusting the post process recipe based an output from the at least one quality measurement and repeating the at least one post processing step with the post processing device using the adjusted post process recipe on at least one the component or a next component.

### FIELD

The present disclosure relates to a system and method for post processing in additive manufacturing.

### BACKGROUND

Additive manufacturing is a process of forming parts by depositing one or more materials layer by layer, “building up” a component. The process generally utilizes digital computer models, such as a computer-aided designs or digital 3D models, sliced into layers, to control the selective deposition, melting, curing, and/or binding of one or more materials. Additive manufacturing accommodates complex geometries without the need for molds or dies. There are a number of additive manufacturing techniques that can be used for the formation of parts from liquid resin materials. For example, stereolithography (SLA) printing uses laser light to cure liquid resin stored in a vat by tracing the layer geometry with the laser. Digital light processing (DLP) uses light projected onto a vat to cure an entire layer of liquid resin all at once.

However, the processes noted above use resin precursors, exhibiting viscosities of less than 10,000 centipoise at room temperature (20 degrees Celsius). In processes for these materials, the resin precursors are generally gravity fed or use pumps to feed material into a printing vat or deposit material. These resins may lead to poor mechanical properties due to the composition of the precursors. As a result, the parts obtained are not always suitable for end-use and industrial applications. These applications include but are not limited to seals, structural brackets, automotive components such as under-the-hood parts and electrical connectors, footwear components including outer soles and orthoses, healthcare applications such as hearing aid components and medical devices, and battery components.

There are many challenges in manufacturing components formed from relatively high viscosity precursors, including cleaning the parts after they have been printed. Often the printed parts will have uncured resin remaining on the parts that needs to be removed. In addition, as the printed part may only be partially cured during the printing process, portions of the part may require further curing after the part is printed. Skilled technicians assist in completing these various processes. However, this may result in process variation and variation in quality.

Accordingly, room remains for improvement of additive manufacturing systems and methods for improved manufacturing resins having viscosities of 20,000 centipoise or greater, including systems and methods for automation of post processing steps and improved consistency in quality control.

### SUMMARY

According to various aspects, the present disclosure relates to a method for post processing a component produced by an additive manufacturing machine. The method includes analyzing one or more input parameters for a component produced by additive manufacturing machine, wherein the input parameters include at least one of material properties, digital geometry, initial weight, type of support structure, support structure material, and number of components printed in a batch, and generating a post process recipe including a process parameter for at least one post processing step. The method further includes executing at least one post processing step with a post processing device using the process parameter and performing at least one quality measurement associated with the at least one post processing step. The method further includes adjusting the post process recipe based an output from the at least one quality measurement and repeating the at least one post processing step with the post processing device using the adjusted post process recipe on at least one the component or a next component.

In embodiments of the above, the method includes manually adjusting an input parameter based on the output from the at least one quality measurement.

In any of the above embodiments, the input parameters for the component include a computer aided drawing file.

In any of the above embodiments, the post processing step includes at least one of spinning, washing, drying, light curing, and thermal curing.

In any of the above embodiments, the at least one quality measurement includes at least one of weight, capturing images, capturing thermographic images, and detecting temperature.

In any of the above embodiments, the method further includes adjusting the process parameter of the at least one post processing step while performing the post processing step on the next component.

In any of the above embodiments, the method further includes repeating the at least one post processing step with the post processing device using the adjusted post process recipe on the component.

In any of the above embodiments, the method further includes repeating the at least one post processing step with the at least one post processing device using the adjusted post process recipe on the next component.

In any of the above embodiments, the method further includes adding a tracking identifier to at least one of the component and a build plate on which the component is formed in the additive manufacturing machine, wherein the tracking identifier links the component with the input parameters of the additive manufacturing machine and the process parameter.

In any of the above embodiments, the method further includes performing a second post processing step on the component with a second post process device, wherein the post process recipe includes a second process parameter for the second post process step, performing at least one second quality measurement associated with the second post processing step, adjusting the post process recipe based on a second output from the at least one second quality measurement, and repeating the second post processing step with the second post processing device using the adjusted post process recipe on at least one of the component and the next component. In further embodiments, the second process parameter is adjusted based on the at least one quality measurement associated with the at least one post processing step prior to executing the second post processing step on the component.

In further embodiments, the method includes performing a third post processing step on the component with a third post process device, wherein the post process recipe includes a third process parameter for the third post processing step, performing at least one third quality measurement associated with the second post processing step, adjusting the post process recipe based on a third output from the at least one third quality measurement, and executing the third post processing step with the third post processing device using the adjusted post process recipe. In embodiments, the third process parameter is adjusted based on the at least one quality measurement associated with the second post processing step prior to performing the third post processing step on the component.

In further embodiments, the method includes performing a fourth post processing step on the component with a fourth post process device, wherein the post process recipe includes a fourth process parameter for the fourth post processing step, performing at least one fourth quality measurement associated with the second post processing step, adjusting the post process recipe based on a fourth output from the at least one fourth quality measurement, and repeating the fourth post processing step with the fourth post processing device using the adjusted post process recipe on at least one of the component and the next component.

According to various further aspects, the present disclosure relates to a system for post processing a component produced by additive manufacturing. The system includes at least one post processing device and a controller in electrical communication with the post processing device. The controller is programmed to analyze one or more input parameters for a component produced by an additive manufacturing machine, wherein the input parameters include at least one of material properties, digital geometry, initial weight, type of support structure, support structure material, and number of components printed in a batch, and generate a post process recipe including a process parameter for at least one post processing step. The controller is further programmed to execute the at least one post processing step with a post processing device using the process parameter, perform at least one quality measurement with a quality measurement device associated with the at least one post processing step, adjust the post process recipe based an output from the at least one quality measurement, and repeat the at least one post processing step with the post processing device using the adjusted post process recipe on the component or a next component.

In embodiments of the above, the post processing device includes at least one of a spinner, a washing system, a dryer, a lamp, and a heating element.

In any of the above embodiments, the quality measurement device include an image sensor. In further embodiments, the post processing device includes at least one of a spinner and a washing system, and the quality measurement device further includes a scale.

In any of the above embodiments, the post processing device includes a heating element and the at least one quality measuring device includes a thermographic camera and an image sensor.

In any of the above embodiments, the system further includes a transfer device configured to transfer the component from an additive manufacturing machine to the at least one post processing device, wherein the transfer device includes at least one of a robot, a conveyor, a motorized gantry system, and a pneumatic system.

### BRIEF DESCRIPTION OF THE DRAWINGS

The drawings described herein are for illustration purposes only and are not intended to limit the scope of the present disclosure in any way.

FIG. 1 illustrates a system according to embodiments of the present disclosure.

FIG. 2 illustrates a flow diagram of the system and methods according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to an automated post-processing cell and methods for automation of post processing steps and improved consistency in quality control. Post-processing cells are understood as systems designed to automatically handle the finishing steps of manufactured parts, such as cleaning, curing, and quality checks. The software for executing the methods may reside in the post-processing cell, onsite with the post-processing cell, or remotely from the post-processing cell.

The systems and method may be used with photopolymer precursors that exhibit pre-cursor viscosities of 20,000 centipoise or greater, such as up to 5,000,000 centipoise. However, while the system and method are described for use with photopolymer precursors exhibiting a photopolymer pre-cursor viscosity of 20,000 centipoise or greater, the system and method may be used with photopolymer precursors exhibiting a pre-cursor viscosity of less than 20,000 centipoise. In addition, while the systems and methods described herein may be used to make seals, structural brackets, automotive components such as under-the-hood parts and electrical connectors, footwear components including outer soles and orthoses, healthcare applications such as hearing aid components and medical devices, and battery components, other printed components may be formed using the system and methods described herein.

The photopolymer polymer precursors exhibit a viscosity of 10,000 centipoise or greater, such as in the range of 1 centipoise to 5,000,000 centipoise, including all values and ranges therein such as in the range of 20,000 centipoise to 100,000 centipoise, 100,000 centipoise to 1,000,000 centipoise, etc. Light, exhibiting one or more wavelengths in the range of 250 nanometers to 750 nanometers, including all values and ranges therein, is used to polymerize the resin precursors. In embodiments, the precursors are cured using light exhibiting one or more wavelengths in the range of 320 nanometers to 435 nanometers, including all values and ranges therein. In embodiments, the polymer precursors include at least one of a monomer and an oligomer, at least one photoinitator, and, optionally, one or more fillers and additives.

The monomers and oligomers include, but are not limited to, one or more of the following: acrylate, methacrylate, vinyl, thiol, epoxy, oxetane, hydroxy, and hydride functional liquid silicones, liquid polyurethanes, urethane monomers, rubbers, and polybutadienes. In further embodiments, the monomers and oligomers include methacrylates and acrylates functional groups on linear, branched, star, or comb urethane, silicone, or polyolefin (polypropylene, polyethylene) backbones. The photoinitators, in embodiments, include at least one of a type I photoinitators such as hydroxyacetophenone (HAP) and phosphineoxide such as diphenyl(2,4,6-trimethylbenzoyl)phosphine oxide (TPO), ethyl (2,4,6-trimethylbenzoyl) phenylphosphinate (TPO-L), phenylbis(2,4,6-trimethylbenzoyl)phosphine oxide (BAPO)), and a type II photoinitiator such as Benzophenone and benzophenone-type photoinitiators, which also require the use of a co-initiator such as an alcohol, amine, thiol or otherwise. The photoinitators (and co-initiators, if present) are present in the range of 0.01 percent by weight to 5 percent by weight, including all values and ranges therein.

The fillers include, but are not limited to one or more of the following: ceramics including silica, alumina, zirconia, ferrites, barium titanate, silicon carbide, silicon nitride, boron carbide, hydroxyapatite, aluminum trihydrate, zinc oxide, and combinations thereof; metals including but not limited to one or more transition metals, which are understood as metals that include valence electrons in two shells instead of only one; and metal alloys, which are understood to include one or more metals or one or more metals with one or more non-metallic elements. Other additives may be added including plasticizers such as dioctyl adipate, diisooctyl phthalate; and additional fillers such as silica in non-ceramic based formulations, glass, and organic materials such as rosin, amine, amide, poly amide, polyurethane, urethane, melamine, phosphinate etc. The fillers are inclusive of all morphology including but not limited to spheres, fibers, flakes, tubes, milled, ground, natural, and cubes. The fillers may be present in the range of 0.1 percent by weight to 90 percent by weight of the total weight of the polymer precursor, including all values and ranges therein such as 0.1 percent by weight to 10 percent by weight, 10 percent by weight to 25 percent by weight, etc. The polymer precursors including fillers may exhibit a viscosity in the range of 20,000 to 5,000,000 centipoise at room temperature (23 degrees Celsius), including all values and ranges therein.

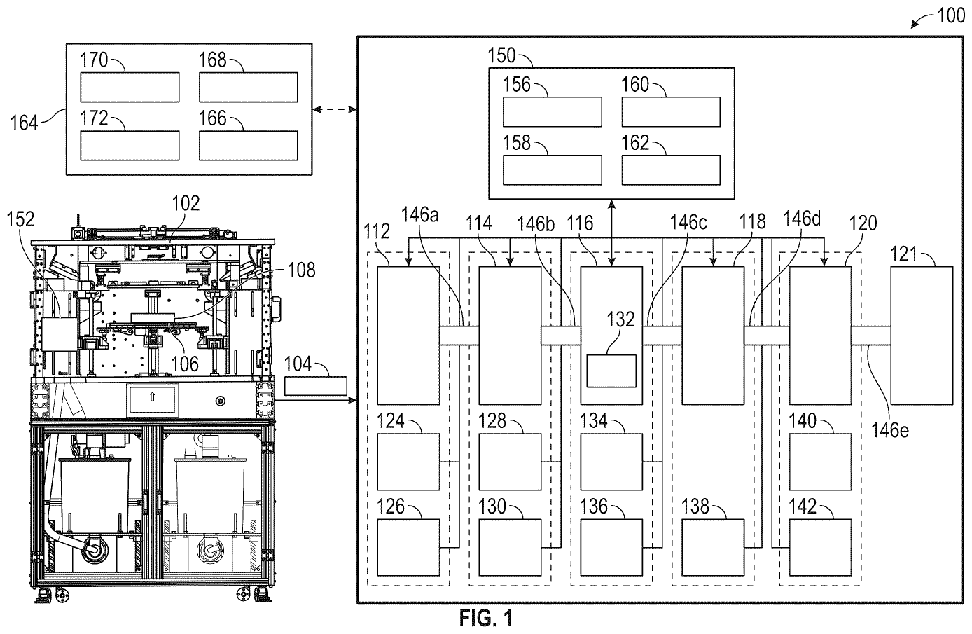

FIG. 1 illustrates an embodiment of a post-processing system 100 for components 108 manufactured using additive manufacturing techniques, and in particular embodiments, manufactured using additive manufacturing techniques for polymer precursors. The system 100 receives a printed component 108 from an additive manufacturing system 102. In embodiments, the component 108 is automatically transferred from the additive manufacturing system 102 using a transfer device 104. The transfer device 104 includes at least one of a robot, a conveyor, a motorized gantry system, and a pneumatic system. Alternatively, the component 108 may be manually transferred from the additive manufacturing system 102 to the post-processing system 100. The build plate 106 on which the component 108 is formed in the additive manufacturing system 102 may be transferred with the component 108 into the post-processing system 100.

Further, in embodiments, prior to or upon transferring the component 108 to the post-processing system 100, a tracking identifier is added to the component 108 or the build plate 106 on which the component 108 was formed to identify the component 108 (or batch of components 108) anywhere in the post-processing system 100. For example, the identifier may include at least one of a near field communication tag, a radio frequency identification tag, a quick-response code, and a barcode, so that the component 108, or a build plate 106 of components 108. The identifier tag may link the component 108 to the process conditions of the additive manufacturing system 102 to form the component 108 and the processing conditions used by the post-processing system 100 to treat the component 108. Manual or automatic scanning of a component 108 or build plate 106 in the post-processing system 100 may be performed at any stage (or related to any post-processing device) or after post-processing is complete and the components 108 exit the post-processing system 100 to provide information regarding the progress of the component 108 through the additive manufacturing system 102 and post-processing system 100.

The post-processing system 100 includes at least one of the following post-processing devices: one or more spinners 112, one or more washing systems 114 such as the washing system available from Supernova Industries, Corp. and described in WO 2023/227661 the teachings of which are incorporated herein by reference, one or more dryers 116 including at least one of an oven and a drying conveyor, one or more lamps 118 for photoinitiator curing, and one or more heating elements 120 for thermal curing. It should be appreciated that a spinner is a device where the build plate including the printed component is placed, secured, and rotated at a controlled speed ranging from 100 rotations per minute to 5,000 rotations per minute. The build plate is positioned in the range of 10 centimeters to 1 meter from the axis of rotation, and the build plate normal vector can be oriented at different angles relative to the direction of tangential velocity. This allows the removal of excess resin, typically removing 90 percent or more. Collected resin drains from the bottom of the spinner, where it can be drained through a ball valve and collected for reuse. In the illustrated post-processing system 100 all five post-processing devices are present; however, it should be appreciated that only one may be present, in the range of 1 to 4 post-processing devices may be present, or more than five post-processing devices may be present, depending on one or more of the following factors: the materials used, the additive manufacturing process used, and the final component geometry desired. Additional post-processing devices include, but are not limited to, vacuum chambers, air jets, a rinsing station, an abrasive blaster using sand, walnut shells or other blasting media, auto-rotation equipment, support removal devices for removing support material that is not removed during washing steps, including but not limited to computer numerical controlled machine including drills, grinders, mills, lathers, routers, etc., and part removal devices including at least one of a robot and a conveyor. In further embodiments, the post processing system includes an oven, spinner, dryer, ultrasonic bath, and UV curing. In embodiments, a manual station 121 is also provided where an operator may perform multiple tasks including one or more of part inspection, support material removal, recovery of built plates 106, and removal of defective components.

The post-processing system 100 also includes at least one quality measurement device for providing at least one quality measurement, i.e., a measurement of part quality. As illustrated, one or more quality measurement devices are provided with each post-processing device. In embodiments, associated with the one or more spinners 112 is a scale 124 for checking component weight and an image sensor 126 such as a charged-coupled device and complementary metal-oxide semiconductor (CMOS) sensors for capturing images; associated with the washing system 114 is a scale 128 for checking component weight and an image sensor 130 such as a charged-coupled device and complementary metal-oxide semiconductor (CMOS) sensors for capturing images; associated with one or more dryers 116 is a temperature sensor 132 for detecting the temperature in the drying environment, a scale 134 for checking component weight, and a thermographic camera 136 capturing infra-red images for measuring thermal data and temperature control; associated with the lamps 118 for photo-initiator curing is an image sensor 138 such as a charged-coupled device and complementary metal-oxide semiconductor (CMOS) sensors for capturing images to determine if curing is complete; and associated with one or more heating elements 120 for thermal curing is a thermographic camera 140 capturing infra-red images and an image sensor 142 such as a charged-coupled device and complementary metal-oxide semiconductor (CMOS) sensors for capturing images to determine if curing is complete.

In addition or alternatively to the quality measurement devices noted above, additional quality measurement devices may be associated with any of the post processing devices described above. Further quality measurement devices include, but are not limited to, computer vision for detecting surface defects, including defects and anomalies that may not be visible to the eye, pressure monitoring for monitoring environmental pressure in the post-processing device environment, dimensional measurement sensors for measuring the size of the component features, surface texture analysis using profilometers or non-contact methods such as atomic force microscopy, focus variation, confocal microscopy, or interferometry, for measuring surface finish, humidity control for monitoring humidity in the post-processing device environment, temperature sensors for measuring temperature in the post-processing device environments, ultrasonic inspection, vibration analysis, colorimetric analysis, X-ray inspection, acoustic emission monitoring, and electrical conductivity testing. The quality measurement device may be included in or integrated into the post-processing device itself or the component 108 may be conveyed to the quality measurement device after treatment with the post-processing device.

In embodiments, the component 108 is automatically transferred between the post-processing devices using the transfer device 104. Additionally or alternatively, one or more additional transfer devices 146a, 146b, 146c, 146d, 146e may be provided between the post-processing devices. For example, in one embodiment, a single transfer device 104, 146a, 146b, 146c, 146d, 146e may be provided between the additive manufacturing system 102 and the post-processing system 102 as well as between all of the post-processing devices in the post processing system 102. In another embodiment, a separate transfer device 104, 146a, 146b, 146c, 146d, 146e is provided between the additive manufacturing system 100 and each of the post-processing devices 102. In yet further embodiments, at least two of the additive manufacturing system 100 and post-processing devices may share a transfer device 104, 146a, 146b, 146c, 146d, 146e. The transfer devices 146a, 146b, 146c, 146d, 146e include at least one of a robot, a conveyor, a motorized gantry system, and a pneumatic system.

The post-processing system 100 also includes a controller 150 connected electrically by electrical connections, such as wires, or wirelessly, to the various post-processing devices 112, 114, 116, 118, 120 and the various quality measurement devices 124, 126, 128, 130, 132, 134, 136, 138, 140, 142. As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 150 may also consist of multiple controllers which are in electrical communication with each other. The controller 150 may be inter-connected with additional systems and/or controllers, such as a controller 152 in the additive manufacturing machine 102, allowing the controller 150 to access data such as the input parameters including, but not limited to, the g-code used to print the component 108, any relevant m-code used to print the component 108, the stacks of high resolution greyscale images corresponding to the cross-sections of the components 108, the original computer aided design file, material properties, digital geometry, initial weight (either estimated from printer data files or actual measured weight), type/geometry of the support structure if present, support-structure material, and number of components 108 printed in a batch. A processor 156 may be a custom made or commercially available processor, a central processing unit (CPU), a graphics processing unit (GPU), an auxiliary processor among several processors associated with the controller 150, a semi composite conductor-based microprocessor (in the form of a microchip or chip set), a macroprocessor, a combination thereof, or generally a device for executing instructions.

Executable code for executing the method described herein is stored in tangible, non-transitory memory 158 accessible by the controller 150. Alternatively, the executable code (otherwise referred to herein as software) may be encoded in the controller 150. Tangible, non-transitory memory 158 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 1404 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 150 to control various systems of the post-processing system 100.

A communication device 160 includes one or more interface circuits. In some examples, the interface circuits include wired or wireless interfaces that are connected to a local area network (LAN), the Internet, a wide area network (WAN), wireless local area networks (WLAN), cellular networks, or combinations thereof. As alluded to above, the communication device 160 provides communication between the controller 150 in the post processing system 100 and the controller 152 in the additive manufacturing system 102. In further embodiments, the communication device 160 provides communication between the controller 150 and an external controller 164 that is located remotely from the post-processing system 100, either on site, such as in on-site servers, or off-site, such as cloud based systems or off-site servers. In cases where an external controller 164 may be present, communication between the external controller 164 and the local controller 150 is facilitated by a communication device 166 located in the external controller. Further, executable code for performing the methods herein may be stored in the tangible, non-transitory memory 168 in the external controller 164 and the external controller 164 may execute the executable code using one or more processors 170 associated therein. Further, the controller 150 and external controller 164, if present, include one or more user interface devices 162, 172, including input and output devices, such as keyboards, keypads, track pads, mice, touch screens, light emitting diodes, and display screens. Use of an external controller 164 allows for the deployment of methods and systems herein under a software as a service (SaaS) model, allowing for automatic updates, remote support, continuous improvements without the need for on-site installations, and expansions.

In additional embodiments, at least one of the controller 150 and external controller 164 may interface with an enterprise resource planning (ERP) system or manufacturing execution system (MES) platform through the communication device 160 and provide output data to the EPR system or MES platform. Output data from at least one of the controller 150, external controller 164, and communication device 160 includes component 108 status, traceability to the production steps in at least one of the additive manufacturing system 102 and post-processing system 100, and quality reporting associated with the components 108 and quality measurements.

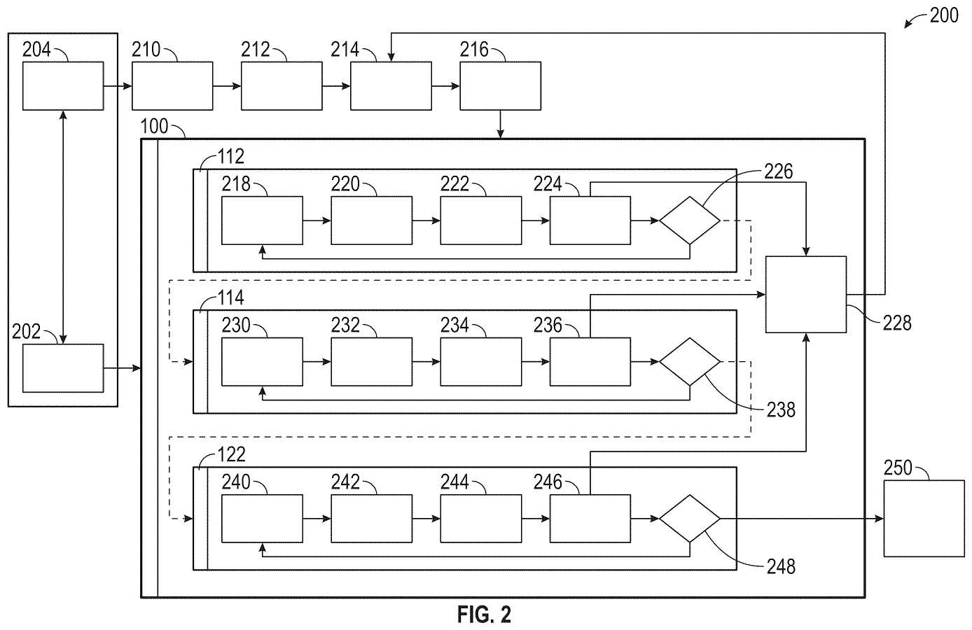

FIG. 2, with further reference to FIG. 1, illustrates a method 200 for post-processing a component produced by additive manufacturing, and particularly for additive manufacturing using photopolymer precursors. At block 202 a newly printed component 108 is provided to a post-processing system 100. As noted above, the newly printed component 108 is labeled, in embodiments, with an identifier tag. The identifier tag may include at least one of a near field communication tag, a radio frequency identification tag, a quick-response code, and a barcode, so that the component 108, or a build plate 106 of components 108. Further at block 204 one or more input parameters regarding the component 108 is provided to the controller 150. The component 108 and input parameters may be provided simultaneously or sequentially. The input parameters include at least one of material properties, digital geometry, initial weight, type of support structure, support structure material, and number of components printed in a batch. In further embodiments, this information may be transmitted to an external controller 164 from the controller 150. Optionally at block 210, the input parameters may be adjusted.

At block 212 the input parameters are analyzed and at least one process parameter for at least one post processing device 112, 114, 116, 118, 120 in the post processing system 100 is selected based on the input parameters. The process parameters include at least one of single data point and a data point range, the data point and data point range optionally includes minimum and maximum tolerances. In embodiments, the process parameters are stored in at least one of: 1) the tangible, non-transitory memory 158 in the controller 150 and 2) the tangible, non-transitory memory 168 stored in the external controller 164. The process parameters may be stored, for example, in look-up tables. At block 214 a post-process recipe is generated including the at least one process parameter for each of the post processing devices 112, 114, 116, 118, 120 that may be present. At block 216 the process parameters in the post-process recipe are communicated to the post-processing system 100 and the various post processing devices 112, 114, 116, 118, 120.

At block 218 a first processing step using a first post processing device, such as spinner 112, is performed using the process parameters from the post process recipe. Process parameters associated with the spinner include spin times, speeds, and target weight loss (or target weight). In embodiments, using the first post processing device may involve multiple steps, including step 218, 220, and 222, each of which may use one or more process parameters from the post process recipe, including, for example, rate of ramping up spinning speeds 218, spinning at a fixed rate for a time period 220, and rate of ramping down spinning speeds 222. At block 224 at least one quality measurement associated with the at least one post processing device is performed. At block 226 a comparison between the output of the at least one quality measurement and the desired target for the at least one quality measurement is made to determine if the output is within a permissible tolerance. If it is determined at block 226 that the output is within the permissible tolerance, the method 200 moves on to the second post processing device, such as washing system 114 at block 230. If it is determined at block 226 that the output is outside of the permissible tolerance, the first processing step is repeated at block 218. At block 228 the at least one quality measurement is stored and, if needed, one or more of the process parameters in the post processing recipe is adjusted at block 214. In embodiments, revised process parameters and a revised post process recipe are enacted upon by the first process device before the component moves to the processing step at block 230, such as while the first processing step is repeated at block 218. Alternatively, the revised process parameters and revised post process recipe are enacted upon for the next component. Additionally, or alternatively, when possible, rather than revise the process parameters for the first processing step, the process parameters for the second processing step at block 230 may be revised to accommodate the out of permissible tolerance output. In further embodiments, if it is determined at block 226 the output is outside of the desired target but the can be remediated in a later post processing step, such as the second post processing step at block 230 (or a later post processing step), by adjusting at least one process parameter for that, later processing step, then the at least one processing parameter for the later processing step is adjusted along with the process recipe for the processing step in which the desired target was missed.

At block 230 a second processing step using a second post processing device, such as washing system 114 is performed using the process parameters from the post process recipe. Process parameters associated with the washing system 114 include washing fluid temperature and number of washing cycles. In embodiments, using the second post processing device may involve multiple steps, including step 230, 232, 234 each of which may use one or more process parameters from the post process recipe, including, for example, immersing the component multiple times. At block 236 at least one quality measurement associated with the at least one post processing device is performed. At block 238 a comparison between the output of the at least one quality measurement and the desired target for the at least one quality measurement is made to determine if the output is within a permissible tolerance. If it is determined at block 238 that the output is within the permissible tolerance, the method 200 moves on to the next post processing device, such as drier 116 at block 240. If it is determined at block 238 that the output is outside of the permissible tolerance, the second processing step is repeated at block 230. At block 228 the at least one quality measurement is stored and, if needed, one or more of the process parameters in the post processing recipe is adjusted at block 214. In embodiments, revised process parameters and a revised post process recipe are enacted upon before the component moves to the next processing step at block 240, such as while the second processing step is repeated at block 230. Alternatively, the revised process parameters and revised post process recipe are enacted upon for the next component. Additionally, or alternatively, when possible, rather than revise the process parameters for the second processing step, the process parameters for the next processing step at block 240 may be revised to accommodate the out of permissible tolerance output.

At block 240 the next processing step using the next post processing device 122, such as dryer 116, photoinitator lamp 118, heating element 120 for thermal curing, or an additional or alternative device is performed using the process parameters from the post process recipe. For example, process parameters associated with the dryer include drying temperature and drying time; process parameters associated with the light curing process include light wavelength, light intensity, exposure time, and number of exposures; and process parameters associated with thermal curing include temperature of the heating elements and duration of thermal exposure. In embodiments, using the next post processing device may involve multiple steps, including step 240, 242, 244 each of which may use one or more process parameters from the post process recipe. At block 246 at least one quality measurement associated with the next post processing device is performed. At block 248 a comparison between the output of the at least one quality measurement and the desired target for the at least one quality measurement is made to determine if the output is within a permissible tolerance. If it is determined at block 248 that the output is within the permissible tolerance, the component 108 is removed from the post processing system 100 at block 250. If it is determined at block 248 that the output is outside of the permissible tolerance, the first processing step is repeated at block 240. At block 228 the at least one quality measurement is stored and, if needed, one or more of the process parameters in the post processing recipe is adjusted at block 214. In embodiments, revised process parameters and a revised post process recipe are enacted upon by the next process device before the component 108 is removed from the post-processing system 100, such as while the next processing step is repeated at block 240. Alternatively, the revised process parameters and revised post process recipe are enacted upon for the next component. At block 250 a final validation of part quality is performed.

The apparatus and methods described in the present disclosure provide a number of advantages. These advantages include a reduction in the need for human involvement to complete post-processing steps, leading to relatively more repeatable processes, reducing the risk of mistakes, and lowering the overall cost per part. It also allows manufacturers to focus their workforce on more valuable tasks, increasing productivity. In addition, automating post-processing helps to standardize operations across different production sites, making it easier for companies to maintain consistent standards and quality regardless of where production is happening. This also reduces the dependency on highly skilled manual labor, which can be difficult and costly to source. These advantages include consistent final product characteristics. By using a control scheme designed around the material and geometry of each part, the process produces uniform results with relatively little variation. This consistency may improve performance in industries like aerospace and medical devices, where meeting high-quality standards is expected. Consistent quality also means fewer defective parts, which reduces rework and waste. This, in turn, lowers production costs and helps companies meet strict regulatory requirements more easily. Furthermore, having a consistent output quality makes it easier to scale up production, as the process can be reliably repeated without sacrificing quality. These advantages further include adjustments to the post-processing recipes each stage of post-processing to reach the desired quality, useful for manufacturers working with different materials or complex shapes, as it allows them to fine-tune each step to meet specific needs. This adaptability improves the overall quality and performance of the product. The ability to adjust the process also means that manufacturers can respond more effectively to changes in customer needs or new industry standards. These advantages further include automated quality checks built into each stage of the post-processing workflow to monitor the quality of parts in real time. These controls help gather data such as dimensional accuracy, surface finish metrics, weight, and temperature readings, which are used to spot issues early and ensure each part meets the quality standards before moving on. This improves the reliability of production and reduces waste, leading to a more efficient and sustainable manufacturing process. Automated quality control also helps in creating a comprehensive record of the production process, which can be invaluable for traceability and compliance purposes. This data can be used for continuous improvement, allowing manufacturers to identify patterns in defects and adjust the process accordingly to prevent future issues. Moreover, real-time quality monitoring can help reduce downtime by quickly identifying and addressing problems before they become significant. The advantages also include continuous updates and expansion of the software. Yet further advantages include The primary use of this solution is as the control scheme for an automated post-processing cell, which is a system designed to automatically handle the finishing steps of manufactured parts, such as cleaning, curing, and quality checks. Another possible use is offering it as a SaaS (Software as a Service) subscription for industrial applications, allowing manufacturers to integrate it with their current 3D printers and quality control systems. For example, using a SaaS model would allow manufacturers to receive real-time updates, remote support, and continuous improvements without the need for complex on-site installations, thereby reducing overhead and ensuring they always have the latest technology. This flexibility makes it suitable for both small and large manufacturers. The modular nature of the system and methods also allows for continuous updates and expansions, making it possible to add advancements in additive manufacturing and quality control technologies. This helps companies stay up-to-date with industry trends, improve product consistency, and meet evolving industry standards. Overall, this invention aims to provide an adaptable, future-proof solution that makes post-processing more accessible, efficient, and cost-effective for the additive manufacturing industry.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for post processing a component produced by an additive manufacturing machine, comprising:
analyzing one or more input parameters for a component produced by additive manufacturing machine, wherein the input parameters include at least one of material properties, digital geometry, initial weight, type of support structure, support structure material, and number of components printed in a batch;
generating a post process recipe including a process parameter for at least one post processing step;
executing at least one post processing step with a post processing device using the process parameter;
performing at least one quality measurement associated with the at least one post processing step;
adjusting the post process recipe based an output from the at least one quality measurement; and
repeating the at least one post processing step with the post processing device using the adjusted post process recipe on at least one of the component or a next component.

2. The method of claim 1, further comprising manually adjusting an input parameter based on the output from the at least one quality measurement.

3. The method of claim 1, wherein the input parameters for the component include a computer aided drawing file.

4. The method of claim 1, wherein the post processing step includes at least one of spinning, washing, drying, light curing, and thermal curing.

5. The method of claim 1, wherein the at least one quality measurement includes at least one of weight, capturing images, capturing thermographic images, and detecting temperature.

6. The method of claim 1, further comprising adjusting the process parameter of the at least one post processing step while performing the post processing step on the next component.

7. The method of claim 1, further comprising repeating the at least one post processing step with the post processing device using the adjusted post process recipe on the component.

8. The method of claim 1, further comprising repeating the at least one post processing step with the at least one post processing device using the adjusted post process recipe on the next component.

9. The method of claim 1, further comprising adding a tracking identifier to at least one of the component and a build plate on which the component was formed in the additive manufacturing machine, wherein the tracking identifier links the component with the input parameters of the additive manufacturing machine and the process parameter.

10. The method of claim 1, further comprising performing a second post processing step on the component with a second post process device, wherein the post process recipe includes a second process parameter for the second post process step; performing at least one second quality measurement associated with the second post processing step; adjusting the post process recipe based on a second output from the at least one second quality measurement; and repeating the second post processing step with the second post processing device using the adjusted post process recipe on at least one of the component and the next component.

11. The method of claim 10, wherein the second process parameter is adjusted based on the at least one quality measurement associated with the at least one post processing step prior to executing the second post processing step on the component.

12. The method of claim 10, further comprising performing a third post processing step on the component with a third post process device, wherein the post process recipe includes a third process parameter for the third post processing step; performing at least one third quality measurement associated with the second post processing step; adjusting the post process recipe based on a third output from the at least one third quality measurement; and repeating the third post processing step with the third post processing device using the adjusted post process recipe on at least one of the component and the next component.

13. The method of claim 12, wherein the third process parameter is adjusted based on the at least one quality measurement associated with the second post processing step prior to performing the third post processing step on the component.

14. The method of claim 12, further comprising performing a fourth post processing step on the component with a fourth post process device, wherein the post process recipe includes a fourth process parameter for the fourth post processing step; performing at least one fourth quality measurement associated with the second post processing step; adjusting the post process recipe based on a fourth output from the at least one fourth quality measurement; and repeating the fourth post processing step with the fourth post processing device using the adjusted post process recipe on at least one of the component and the next component.

15. A system for post processing a component produced by additive manufacturing, comprising:
at least one post processing device; and
a controller in electrical communication with the post processing device, wherein the controller is programmed to:
analyze one or more input parameters for a component produced by an additive manufacturing machine, wherein the input parameters include at least one of material properties, digital geometry, initial weight, type of support structure, support structure material, and number of components printed in a batch;
generate a post process recipe including a process parameter for at least one post processing step;
perform the at least one post processing step with a post processing device using the process parameter;
perform at least one quality measurement with a quality measurement device associated with the at least one post processing step;
adjust the post process recipe based an output from the at least one quality measurement; and
repeat the at least one post processing step with the post processing device using the adjusted post process recipe on the component or a next component.

16. The system of claim 15, wherein the post processing device includes at least one of a spinner, a washing system, a dryer, a lamp, and a heating element.

17. The system of claim 15, wherein the quality measurement device includes an image sensor.

18. The system of claim 17, wherein the post processing device includes at least one of a spinner and a washing system, and the quality measurement device further includes a scale.

19. The system of claim 15, wherein the post processing device includes a heating element and the at least one quality measuring device includes a thermographic camera and an image sensor.

20. The system of claim 15, further comprising a transfer device configured to transfer the component from an additive manufacturing machine to the at least one post processing device, wherein the transfer device includes at least one of a robot, a conveyor, a motorized gantry system, and a pneumatic system.
